(19) United States
(12) Patent Application Publication
(10) Pub. No.: US 2020/0406542 A1
(43) Pub. Date: Dec. 31, 2020

(54) ELECTROHYDRODYNAMIC BIOPRINTER AND METHODS OF USE

(71) Applicant: FRONTIER BIO CORPORATION, Oakland, CA (US)

(72) Inventor: Eric Bennett, Oakland, CA (US)

(73) Assignee: FRONTIER BIO CORPORATION, 8000 Edgewater Dr, Ste 200, CA (US)

(21) Appl. No.: 17/013,784

(22) Filed: Sep. 7, 2020

Related U.S. Application Data
(63) Continuation of application No. PCT/US19/21834, filed on Mar. 12, 2019.
(60) Provisional application No. 62/642,588, filed on Mar. 13, 2018.

(51) Int. Cl. B29C 64/209; B29C 64/245; B29C 64/165; B29C 64/188; B29C 64/343; B29C 64/35; B29C 64/393; B29C 64/236

(52) U.S. Cl. CPC B29C 64/209; B29C 64/245; B29C 64/165; B29C 64/188; B33Y 30/00; B29C 64/35; B29C 64/393; B29C 64/236; B29C 64/343

(57) ABSTRACT

According to an embodiment of the disclosure, a device with the capability of performing both conventional bioprinting and electrohydrodynamic printing (EHDP) is provided. The disclosure also provides methods of using the described device, methods of optimization of printing parameters, methods of position calibration, methods of selecting or creating voltage waveforms, and other methods relating to the fabrication device.

### RELATED APPLICATIONS/PRIORITY

This application is a continuation of PCT Application No. PCT/US2019/021834 (filed on Mar. 12, 2019), which claims priority to U.S. Provisional Application Nos. 62/642,588 (filed on Mar. 13, 2018). The application incorporates both by reference herein for all purposes.

### FIELD OF USE

The present invention relates to an additive manufacturing device useful in printing 2D or 3D structures using bioprinting and electro-hydrodynamic techniques combined in one machine. More specifically, this disclosure is directed to an electrohydrodynamic bioprinter system and method.

### BACKGROUND

Tissue engineering and regenerative medicine have the potential to address the world's organ shortage problem, replace animal testing, and allow humans to live longer healthier lives. Bioprinting has recently become a useful tool for precisely placing cells and other material to create tissue constructs. Conventional bioprinting technologies exist including thermal inkjet printing, piezo-based inkjet printing, pneumatic extrusion, positive-displacement extrusion, laser-assisted bioprinting, and fused filament fabrication.

Most bioprinting machines are limited to only one bioprinting technology, for example pneumatic extrusion. However, it is useful to combine multiple bioprinting technologies into one machine so that a single printing session can benefit from multiple bioprinting methods that may be required for complex tissue constructs.

Other advanced fabrication techniques exist that use a strong electric field to deposit material and these techniques can be referred to as electrohydrodynamic printing (EHDP) techniques. These EHDP techniques are typically used for applications that do not involve the depositing of cells, but EHDP techniques have been used with cells and can be considered a type of bioprinting. EHDP techniques include electro-spinning, electro-spraying, and EHDP droplet jetting (also referred to as electro-droplet jetting or EDJ) and can be performed with or without cells.

While EHDP is more advanced, conventional bioprinting technology is still useful. EHDP alone has been shown to be able to create extremely precise structures, even below 50 nanometers. EHDP alone has also been shown to be able to print cells without causing any damage to them whatsoever in many cases. While EHDP surpasses conventional techniques in certain aspects, conventional techniques are still useful for bioprinting. There is a need in the pertinent art for a machine that combines EHDP techniques with conventional bioprinting techniques

### BRIEF DESCRIPTION OF THE DRAWINGS

For a more complete understanding of this disclosure and its features, reference is now made to the following description, taken in conjunction with the accompanying drawings, in which:

FIG. 1 shows a schematic illustration of a 3D printer system, according to an embodiment of the disclosure;

FIG. 2 shows a schematic illustration of an internal mixing version of a printhead, according to an embodiment of the disclosure;

FIG. 3 shows a schematic illustration of a manifold version of a printhead, according to an embodiment of the disclosure;

FIG. 4 shows a cross-sectional view of an alternate type piezoelectric printhead, according to an embodiment of the disclosure;

FIG. 5 shows a cross-sectional view of an alternate printing surface 2 with wells for receiving a multiplicity of build materials in a prescribed manner;

FIG. 6 shows a bioprinting platform housing multiple extrusion technologies, according to an embodiment of the disclosure;

FIG. 7 shows an ear-shaped porous implantable scaffold printed using an FDM extruder, according to an embodiment of the disclosure;

FIG. 8 shows a triple concentric circular print which used 3 pneumatic extruders, according to an embodiment of the disclosure;

FIG. 9 shows a nose-shaped print with a hydrogel material, according to an embodiment of the disclosure;

FIG. 10 shows a flexible ear-shaped PDMS construct formed by casting PDMS into an FDM-printed ABS mold, according to an embodiment of the disclosure;

FIG. 11 shows flexible, thin tubular PDMS constructs, according to an embodiment of the disclosure;

FIG. 12 shows a nanofibrous blood vessel scaffold being pulled of a metal rod, according to an embodiment of the disclosure;

FIG. 13 shows nanofibers aligned perpendicularly to each other printed with an electrohydrodynamic printhead, according to an embodiment of the disclosure;

FIG. 14 shows a blood vessel model printed to simulate a blood clot, according to an embodiment of the disclosure; and

FIG. 15 shows a blood vessel model printed to simulate a blood clot, according to an embodiment of the disclosure.

### SUMMARY OF THE DISCLOSURE

According to an embodiment of the disclosure, a device is provided that has the combined ability of both conventional bioprinting and electrohydrodynamic printing (EHDP) as well. The device contains a pneumatic system to support the pneumatic extrusion of materials and also contains a high voltage power supply to support EHDP. The device can also have integrated positive displacement pumps. The high voltage power supply can supply a voltage that can be controlled in such a way as to provide high voltages that are either stable over time, or have very specific waveforms such as on and off pulsing, sinusoidal-like waves, or arbitrary waveforms. The parameters for each EHDP extruder during printing can be controlled independently including the voltage, flow rate, pressure, waveform, and temperature for example. A monitoring system to visualize the printing dynamics can also be included in the device. Methods for printing and calibration using the system are also described such as extruder offset calibration, printing parameter optimization, combined bioprinting modality printing, and more. The printing techniques executed by the machine can be done with or without cells.

Before undertaking the DETAILED DESCRIPTION below, it may be advantageous to set forth definitions of certain words and phrases used throughout this patent document:

Additive manufacturing—a method in which material is deposited or formed (usually layer by layer) to create an object.

Bioprinting—a term used to refer to a category of additive manufacturing in which the printed materials either contain living materials, or will be used in a living system. Examples include the printing of a hydrogel that contains stem cells, the printing of gels or scaffolds that will be seeded with cells after printing, the printing of organs, and the printing of prosthetics that can be used in a human or other animal.

Electrohydrodynamic printing—abbreviated as EHDP—a method of additive manufacturing in which the material to be deposited is transported with the facilitation of an electric field.

EDJ—an abbreviation for electro-droplet jetting—which in this patent refers to an EHDP technique in which a brief electric field pulse causes droplets to be emitted from an orifice or surface.

Extruder—a tool that is used to deposit material onto a printing surface. Frequently, this is a syringe barrel that allows material to be pushed out of an attached needle, but other types of apparatuses can also be referred to as an extruder. Another example is an apparatus that melts plastic filament and pushes it out of a nozzle.

FDM—Fused Deposition Modeling. Also known as FFF (Fused Filament Fabrication) or thermoplastic printing. It is an additive manufacturing technique in which molten thermoplastic is deposited layer by layer to create a three-dimensional object.

Printhead—an object that is mounted onto a gantry that allows one or more fabrication tools to be mounted to it and transports the movement of the tools in at least one dimension.

Printer—this term is used to denote the entire system and apparatus used for fabrication and rapid prototyping.

Printing surface—typically this is the surface that extruded material from a printhead is deposited onto. The surface can be planar or curved. The surface can be organic or inorganic. The surface can be stationary or non-stationary. The printing surface could be a flat stainless-steel sheet for example, or it could be a moving hand. In one embodiment of the disclosure the printing surface may be live tissue. In another embodiment of the disclosure the printing surface may be nanoporous or microporous.

The terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

It will be understood that well known processes and components have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

The disclosure relates to improved devices for applications in regenerative medicine and tissue engineering. Disclosed herein, in certain embodiments, are devices, systems and methods, for fabricating scaffolds, tissues, and organs. The described devices and methods are not limited to bioprinting applications but can be inclusive to additive manufacturing in general.

Conventional bioprinting techniques include pneumatic-based extrusion, fused deposition modeling extrusion, positive displacement extrusion, microvalve jetting, piezo-based inkjet extrusion, and thermal inkjet extrusion. Most commercial systems for bioprinting are either pneumatic or positive displacement-based.

Electrohydrodynamic printing (EHDP) techniques are methods in which the motion of the material which is being deposited is primarily caused by an electric field. EHDP encompasses a number of techniques that include but are not limited to electro-spinning, electro-spraying, and electro jetting. Electro-spinning generally results in very fine threads of material being printed. Electro-spraying generally results in a spray of fine electrically charged droplets. Electro-droplet jetting (EDJ) generally results in droplets or short streams of material being emitted one by one from a surface or orifice. EHDP methods can be performed with or without cells mixed with the material that is being extruded. Using EHDP with cells has been previously shown to result in a high cell viability and little or no cell damage in certain cases.

In a preferred embodiment, a fabrication device contains equipment which would allow the device to perform conventional bioprinting techniques and to also perform EHDP techniques within the same printing session. The device can contain within or outside of its housing a high voltage DC power supply, powered by AC or DC voltage. The maximum voltage from the power supply can be in the range of one hundred volts up to one hundred thousand volts. Typically it would be in the range of one thousand volts to thirty-thousand volts.

The high voltage power source can have an output voltage which is manually controlled. A manually controlled source can have a knob or user interface that allows the user to select the desired voltage. The user interface for the high voltage power source can allow the user to select various waveforms including pulsing parameters such as frequency, duty cycle, intensity, rise time, fall time, and other parameters associated with the power source output capabilities. The interface could allow various settings to be saved so that groups of settings could be stored and retrieved and applied at the press of a button.

Optionally, the voltage can be controlled with g-code commands that are entered by a user into a terminal or launched by the press of a button. Optionally the voltage controlling g-code commands can be generated by slicing software or a post-processing script. Optionally the firmware controls the voltage directly. The g-code can optionally be interpreted by the firmware to launch certain waveforms or expected behavior of the voltage source output. G-code commands can also optionally control various other characteristics of the applied voltage or also any other parameters or settings previously or later mentioned in this patent.

The concentration of certain chemicals, molecules, or ions can be adjusted by using g-code commands or some other interface which results in the mixing of certain chemicals, molecules, or ions into the reservoir. This can be done in the middle of a print, before a print, or during calibration of the printing parameters and settings. The mixing can be facilitated by the use of a magnet and/or electromagnet. For example, a magnet could be placed inside the syringe and an electromagnet could be placed outside of the syringe to control the spinning of the magnet when the mixing command was received. Other mixing methods can also be used. The mixing methods can be used to mix cells that may be in the material in order to prevent settling or to help with heat distribution for example.

The high voltage power source can also have an output voltage which is automatically controlled in a coordinated fashion during a print. For example, the user could prepare the parameters and options of the print beforehand on a computer which is built into the fabrication device or exists outside of it. The user could select the desired printing and voltage parameters for each material to be printed. For example, the user could select three different flow rates for each of three materials to undergo EHDP, followed by the selection of a different voltage for each one, and different frequencies, duty cycles, and other parameters. During the print, when an extruder becomes active, the settings that the user had previously chosen during print setup on the computer now become active for the active extruder or extruders. If only one extruder is meant to extrude at a time, then when one extruder becomes active, the others become inactive and each extruder takes turns printing its portion of the print.

In one embodiment, only one high voltage source is used and techniques are used to apply the desired voltages to each separate material to be printed independently. If each extruder requires a different voltage, then the single high voltage power source can automatically change its output voltage to the voltage that the active extruder requires and change its output voltage characteristics for whatever extruder becomes active. Optionally, a voltage source can be used that has more than one output terminal. For example, a voltage source could have one output for every extruder that can be used in the fabrication device, or it could have more outputs for other aspects of the printer such as one or more deflection plates or one or more focusing rings which will be described later. Alternatively, multiple voltage sources can be used.

The user can also create custom voltage or current waveforms for use with the fabrication device. The user can create or specify the waveforms by using one or more of the following non-limiting options: using a touch screen, entering mathematical equations, or choosing from a wide variety of template waveforms with parameters that can be specified. The user can optionally specify the waveform indirectly by describing or selecting in some way the desired characteristics of the printed material including but not limited to droplet size and thread width. In this case, a software program would take the desired characteristics and optionally the other printing parameters (such as the distance from extruder orifice to the printing surface, temperature of the air, humidity, temperature of the material, and other parameters), and determine an approximation of one or more of the desired print settings (such as voltage intensity, frequency, duty cycle, and waveform for example). Optionally, a calibration sequence can be run automatically or semi-automatically or manually such that the print settings become optimized through each iteration of the calibration sequence, or continuously throughout the calibration process.

Examples of voltage waveforms that the user could select from or create are: square wave, sinusoidal, exponential, see-saw, slow ramp up of the voltage (over a period of seconds or minutes), fast ramp (over the period of a repetitive cycle), triangular wave, complex wave, or nonlinear. The waveform examples given could be DC or AC waveforms. The examples given are not limiting and the user can use any combination of the examples given.

A calibration process can optionally use one or more cameras that capture images or video and process them in real-time or have it stored for later processing. For example, a camera could capture images of a thread of material that is being pulled from a needle during electrospinning and also optionally be accompanied by the use of fluorescent imaging to capture images of cells if they are present in the solution being electro-spun. An algorithm could determine the width of the thread and automatically adjust the voltage being applied to the needle or the solution, or the flow rate could be adjusted, or the height of the needle relative to the printing surface could also be adjusted, among other things in order to optimize the settings in order to adjust the thread width to match more closely with what the user input as the desired width for example. The user can optionally select which print setting should be adjusted based off the feedback of the algorithm.

The printing surface can be grounded itself, or a surface or other object could be grounded underneath the printing surface. The high voltage from the power source can be directed to the needle of the extruder or reservoir, or to the reservoir itself, or to the solution itself. Optionally, the reservoir itself or an attachment can have a surface with one or more orifices. Optionally the reservoir or an attachment to it can have numerous orifices such as one thousand or ten thousand or more orifices to allow the material to exit from numerous orifices to create multiple streams of threads or droplets of the material to be printed. Optionally the high voltage can be applied to all or some extruders simultaneously. Optionally the high voltage can be applied to a deflection plate, a ring, or other object. Optionally, the value of the voltage to a deflection plate, ring, or other object is controlled by the use of a voltage divider, voltage regulator, or some other means which would allow the use of fewer voltage sources to create voltages of different values from one source.

The extruders can be located above the printing surface and if needles are used, they can be pointed at the printing surface. Alternatively, the extruders can be pointed not directly at the printing surface, for example they can be pointed orthogonally to the printing surface. Optionally, the printing surface can be located above the extruders or to the side. The printing surface can be a flat surface, wavy surface, cylindrical collector, a spinning mandrel, a set of stationary collectors, or any arbitrary shape or set of shapes. The printing surface can be stationary or move independently from or in coordination with the extruder. The printing surface does not necessarily have to be directly grounded. The printing surface can have a resistive or dielectric material placed between the surface and the grounded surface.

A grounded needle or thin object can be placed underneath the printing surface to act as a localized point of grounding in order to help focus the direction of the printed material. This grounded needle or thin object could be stationary or it could move in the XY dimensions in synchrony with the extruders on the other side of the printing surface. One purpose of moving it in synchrony in the XY dimensions with the active extruder is to increase the focus of the material that is being printed. Alternatively, the printing surface can contain within it or underneath it or above it, an array of objects (such as electrodes) that can be grounded independently of each other, or whose voltage can be controlled independently of each other in order to control the shape of the electric field and to guide the deposition of the extruded material. This can be used to help control the depositing of material. The printing surface in this case can be dielectric or of low conductance or with some resistance and can optionally also be grounded.

As an alternative to applying ground in any of the mentioned embodiments, a negative voltage can be applied instead. Additionally, voltage waveforms can be applied which can be positive, negative, 0, DC, or AC.

The high voltage can be applied to other electrodes near the needle. The electrode or electrodes can be in the shape of a ring, cylinder, cone, or plate for example. These electrodes can be mounted to the printhead or to the printer frame or elsewhere and be stationary. They can optionally be motionless relative to the motion of the extruder. Optionally the electrodes can move with the extruder, but then automatically or manually be moved to the vicinity of a different extruder. This can be useful for using the same electrodes for each different extruder. Optionally different electrodes or plates can have different voltages applied to them. The distance of the electrodes to the extruder exit orifice can optionally be increased or decreased in any dimension automatically or manually. For example, an electrode's distance from a needle of an extruder could be adjusted during a calibration process. As another example, the electrode's distance from the needle of an extruder could be adjusted in the middle of a print by the use of a stepper motor and threaded rod. The electrodes can be used to control the focus of the extruded material. The electrodes can also be rotated around the extruder at a desirable speed optionally with the help of a commutator. Optionally, each electrode can be moved independently by use of actuators or by manual manipulation at any time before, after, or during a print.

In one embodiment, the electrodes in the vicinity of the extruder can be arranged and charged in a way that allows the extruded material to be deposited in a coordinated fashion. In one example, three independent high voltage sources are used to charge three electrodes surrounding the needle of an extruder, and one voltage source is used to create the intermittent jetting of material from the extruder, and the voltage at each electrode is adjusted for each emitted droplet such that each droplet is deposited in a controlled manner to form an array of deposited droplets. Three or more electrodes could be used to guide the material to specific locations on the printed surface.

In one embodiment, multiple reservoirs holding different materials have a tube or needle that directs the materials to a close proximity to each other. This can be useful in bringing all exit orifices for each material to an area near the center of an electrode or group of electrodes.

A software program can be used to suggest or determine the best way to combine the different printing modalities to achieve the desired effect. Software can also be used to automatically determine how the voltage waveform should change over time during a print to achieve a desirable result. For example, sometimes it is desired to increase the electro-spinning or electro-spraying voltage during a print as the printed material gains height. The software program can optionally predict how the voltage should be modified in order to obtain the desired result. The printed material can potentially bock or diminish the electric field created with the high voltage, so having a software program to determine how the voltage should be increased as the layers accumulate is helpful.

A method of printing a structure such as a tissue scaffold can be performed by rotating one or more electrodes that are at high voltage around or near the vicinity of the exit orifice of a material's extruder while also adjusting the voltage being applied to the electrode or electrodes or by adjusting other parameters such as its distance to the orifice. For example, a needle of an extruder can be charged to a high voltage and a copper electrode plate could be set to a different high voltage and reside to the left of the needle. Then, the electrode could be rotated around the needle at a fast speed while material is being extruded. This would cause material to be repelled from the electrode such that the thread or stream of droplets would be deposited in a circular pattern on the printing surface. However, if the voltage to the electrode were decreased gradually during extrusion in this fashion, then the thread or stream of droplets would gradually be deposited in a smaller and smaller circular pattern. If the flow rate, the rotation of the electrode, and the adjustment of the electrode's voltage were set appropriately, the printing of a single layer could be performed in a very fast manner while only needing to control the voltage to two levels.

An alternative method of printing is to have motionless electrodes around the needle and to apply coordinated voltages to them in order to direct the flow of material to specific locations on the printing surface. This is analogous to how a cathode ray tube television works when directing the motion of charged electrons towards precise spots on a screen.

In one embodiment, the printing surface is a flat thin sheet that can be actuated to move in the same dimension that the extruders are lined up in in order to accommodate space for other things or to allow the fabrication device to be manufactured to be smaller. For example, if the extruders are lined up side by side in the left-right direction (as viewed from a user facing the printer), then the printing surface can be actuated to move in the same left-right direction. During a print, the surface could be moved all the way to the right allowing the extruders to be able to reach only the left half of the printing surface. Then, when the right half of the printing surface is needed, the actuator can move the stage all the way to the left so that the extruders can now access the right half of the printing surface. Using this method, one half of the printing surface can be used for printing, and the other half can be used as an area for calibrating any of the EHDP extruders or any other extruder. Alternatively, one half of the printing surface can be used as a cleaning station that contains various mechanisms and methods of cleaning or preparing the extruders for printing, before, after, or in the middle of a print.

The printing surface or what it mounts to or rests on can have modular features. For example, the user could loosen one or more thumb screws to remove the printing surface and replace it with another. This can be useful if different stages are needed for different sized petri dishes or other kinds of containers or surfaces. It can also be useful for using a printing surface that has built-in features like special temperature control abilities or electrical terminals or built-in cameras or built-in electrode arrays.

Additionally, the device can have within or outside its housing, one or more positive displacement pumps such as a syringe pump. The positive displacement pumps can alternatively be located on the printhead. The purpose of the positive displacement pump is to control the flow rate of the material being extruded from each reservoir. The pump can be located on the printhead or could be located elsewhere within or outside the printer. If located off of the printhead, then a tube or channel directs the flow of material to an area of the printhead such that it is mounted and moves with the printhead.

The fabrication device can also contain equipment allowing the device to intake pressurized gas for the purpose of pneumatic extrusion or for the execution of other conventional bioprinting techniques. The device can also contain a compressor or a compressed gas chamber to supply the pressure. The pressurized gas can also be used to create flow of material from the reservoirs that are being used for EHDP as an alternative to using a positive displacement pump.

The temperature of the reservoirs and the material can be controlled. The printing surface temperature can be controlled as well. In one embodiment, the device has a door that can be opened and closed and creates an air-tight or near air-tight seal when it is closed such that there is little to no leak of air into or out of the main chamber of the device. Clean air can be flowed into the chamber to create a positive pressure within the chamber in order to ensure that the flow of air is always exiting the chamber and not entering the chamber (aside from the clean air that is being intentionally flowed in). The ambient temperature, the humidity, and the concentration of gases in the ambient air can also be controlled when the chamber door is closed and can be controlled by g-code, a graphical user interface, or other method. Additionally, an optional capability is the control of the pressure within the device so that experiments could be run within a higher or lower pressure than the pressure that is outside of the machine. For example, electro-spinning could be done while the pressure inside the device is set to a value close to a vacuum in order to affect the evaporation rate of the solvent during electrospinning and ultimately to adjust various things such as the fiber diameter, porosity, and other characteristics of the printed material.

The fabrication device can include sterilizable gloves that are built into the frame or door of the unit in order to allow handling of the fabricated structures or interact with the inside of the machine without compromising the sterility of the inside of the device. The device can have a part of its frame able to interface with the frame of other devices that are made specifically to interface with the device. This can be useful for situations in which a user wants to transfer the printed object to another device without leaving a sterile environment. For example, the fabrication device could be interfaced with a bioreactor, an incubator, or other device by the user without having to open the door of any of the devices because the devices are connected through an interface built into the frame of each device.

The fabrication device includes several subsystems to enrich the fabrication device's functionality. A light source such as an LED or multiple light sources can be mounted on the printhead to be used as tools that cure curable (cross-linkable) materials. Actuators such as stepper motors can exist for each extruder or tool to allow it to move up and down independently of the other extruder or tools. A digital microscope or microscopes can be mounted on the printhead near the extruder and be stationary relative to the extruder to allow the user to monitor extrusion in real-time or to monitor the print. The device can also contain sensors, actuators, or both in order to perform software-based auto-leveling or mechanically actuated auto-leveling. The device can also contain sensors, actuators, or both in order to perform XY and optionally Z calibration of each extruder orifice.

A method of offset calibration can be performed by the machine. The method consists of using one or more ultrasonic transmitters and receivers. The needle of an extruder can be brought near the transmitter and receiver which are aligned with each other in the Y dimension. Then the needle can be moved back and forth between the transmitter and receiver while the position and sensor data is recorded or analyzed. The data can be used to find the center of the needle in the Y dimension. This can be repeated for the X dimension. A small pinhole opening in a material that blocks the ultrasonic waves can be positioned in front of the receiver. The needle can be made to move to block the pinhole, and the needle can be moved upwards until the pinhole becomes unblocked. During this procedure, the position data is stored or analyzed and the Z offset can be obtained from this data or analysis. The process can be repeated to obtain more readings and the results can be averaged. The entire process can be repeated for multiple extruders. The offset calibration process as well as other calibration processes can happen before a print, mid-print, or after a print and can be launched at any time by the user or at regular intervals during the print. The distance between the transmitter and receiver can be adjusted manually or automatically to accommodate larger or smaller tools which is useful when switching from the calibration of a thin needle to the calibration of a large FDM nozzle. The described offset calibration can be performed using alternative transmitters and receivers such as but not limited to a laser or LED as the transmitter and photosensitive sensor as the receiver.

An alternative method of offset calibration can be performed by the device. The nozzle or needle or other exit orifice (a needle will be used in this embodiment) can be made to automatically or manually move between two pairs of sensors. The sensors can face each other and can be aligned in the X or the Y or Z dimension. The needle can be moved back and forth between the sensors in the X, Y, or Z dimension while each sensor captures their data. The data can be used to determine the relative or absolute offset of the needle. For example, the needle could move back and forth in the X and Y dimension and move to various XY coordinates until the outputs of each sensor become approximately equal—then that coordinate will help determine the relative offset of the needle compared to the other needles. Examples of sensor types that can be used include but are not limited to capacitive, electrostatic, or inductive. The needle, nozzle, or other exit structure can be given a charge by the direct or indirect application of a voltage so as to increase the detectability of the needle, nozzle, or other exit structure when using an appropriate sensor.

In the above-mentioned offset sensing methods, and for other methods of offset calibration, the same sensor or sensors that are used to determine the offset in one dimension can also used to determine the offset in another dimension simply by rotating the sensors ninety degrees with an actuator. For example, if a photo-interrupter is used to detect the Y offset of a needle, then the photo-interrupter can be rotated 90 degrees and be used to detect the X offset. In another example, a camera with machine vision is used to detect the position of a needle, and it is rotated 90 degrees to detect the position in the other dimension. In some cases, it may be useful to rotate the sensor 180 degrees. In another method, a camera or other light-based sensor is used in conjunction with mirrors that direct the incoming or outgoing light in a way that allows the sensor to stay stationary, but to also help determine the offset in more than one dimension. In another method similar to the previous method, galvanometers are used to direct the incoming or outgoing light in order to help sense the needle or other structure from different directions or angles in order to determine the offset in more than one dimension.

In one embodiment, the printing surface is previously machined or patterned to have nano or micro features. Electrohydrodynamic printing is then used to deposit material onto the printing surface. The machined or patterned surface acts as a mold in this case and the printed material takes the shape of the printing surface which can be used for a variety of purposes. In one example, a printing surface is machined to have an array of microwells. Electro-spinning is performed onto the printing surface to obtain a nanofiber sheet which itself now contains the micro well shape. Following this, material can be printed into the nanofibrous microwells. The material can be cells, nanoparticles, microparticles, a hydrogel, or a liquid for example. The material can be deposited using conventional printing techniques, or the deposition can be guided by electrodes underneath the microwells. Then, another layer of nanofibers can be deposited to trap the aforementioned printed material in the microwell. A laser mounted on the gantry could then laser cut the microwells. Alternative to a laser, a machined piece can be used to punch out the containers. The result is a large number nanofibrous containers containing a payload that can be a nanoparticles or cells for instance for applications in drug delivery, cancer detection, or therapeutics. Alternatively, microwells are not machined and instead, one sheet is electrospun, the payload added, and another sheet electrospun to trap the payload between the two sheets, then laser cutting or a punching method is used to extract the payload which is encapsulated in the electrospun nanofibers. Optionally, a post-processing step such as crosslinking is used prior to extraction.

The following FIGURES (and corresponding discussion) are also provided to give additional context to embodiments of the disclosure.

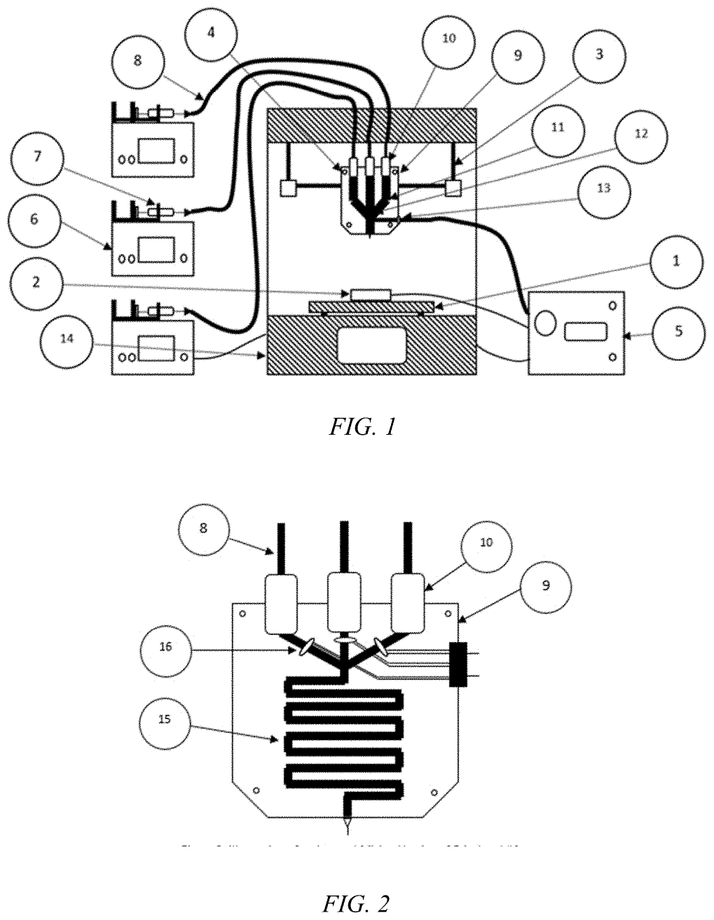

FIG. 1 illustrates a schematic of an embodiment of the present invention which houses a printing surface platform 1, a printing surface 2, an X,Y,Z moveable gantry 3, and a printhead 4. Outside of the machine exists a high voltage source #5, one or more positive displacement pumps 6, each of which house a syringe 7, connected to the material flow tubes #8. The printhead 4, consists of a main body 9, one or more input connections 10, one or more channels 11 that merge into a single reservoir 12, an electrical connector 13, and a conductive substrate 14 which conducts the high voltage to the liquid or to a conductive surface that is in contact with the liquid.

By adjusting the flow rate of each syringe, specific ratios of each liquid can be mixed together near the output orifice. In one embodiment, each syringe pump causes a positive flow of each liquid solution. In another embodiment, one or more syringe pumps cause a negative flow of liquid solution. In one example, one syringe can have a very high concentration of polymer while the other syringe has a very low concentration or only contains the solvent and no polymer. By adjusting the flow rate of each liquid independently, a wide range of polymer concentrations can be created at the output. This can be used to continuously adjust the size of the fibers that are printed, or to switch from one form of extrusion to another (such as from electrospinning to electro-spraying). Or as another example, the ratio of three types of cells can be varied by varying the flow rates of syringes which contain different cell types during bio-electrospraying. This can be useful for printing a layer of cells with a gradient of cell type concentrations.

FIG. 2 illustrates an internal mixing version of the printhead 4 in which a mixing channel 15 is added after the three channels merge in order to better mix the input liquids. Also shown are valves 16 that can control the opening and closing of channels binarily. Optionally, the valves can control the flow rate by acting as flow control valves if the flow of liquid is driven pneumatically.

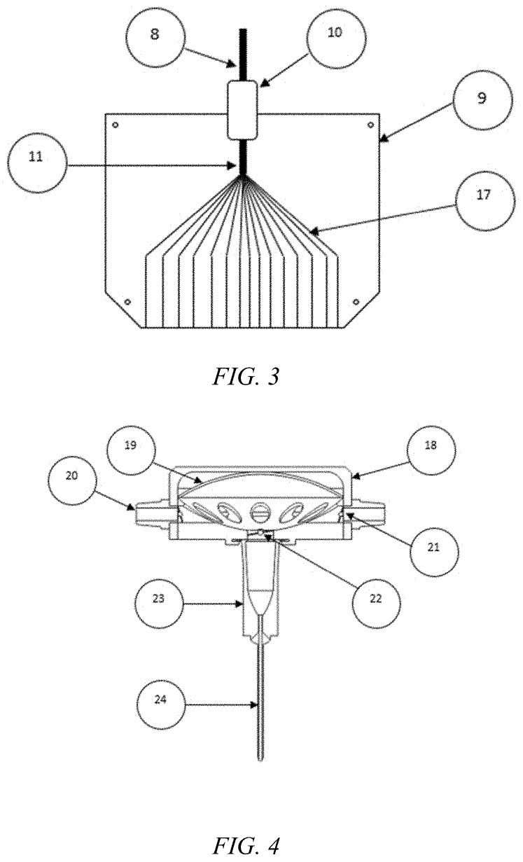

FIG. 3 illustrates a manifold style version of the printhead #4 in which one input channel 11 is split into a multiple channel array 17 within the printhead 4, wherein each channel array 17 leads the build material to an opening from which a multiplicity of build material emerges. The purpose of this embodiment would be to produce multiple nanofibers or nanoparticles from a single channel 11, for reasons that include high throughput generation of fibers and/or for a more uniform creation of fibrous constructs.

FIG. 4 is a cross-section of an alternate embodiment of the printhead 4 which contains a piezoelectric actuator (pump) with a multiplicity of inputs 20 and one output. The printhead has a body 18 with a piezoelectric actuator 19. The printhead 4 also has an electrically conducting removable outlet 23 with a precision needle deposition tip 24. Each input will have a check valve 21 and the output will optionally have a check valve 22. The electrically conducting removable outlet 23 may contain a spiral mixing insert which is not shown.

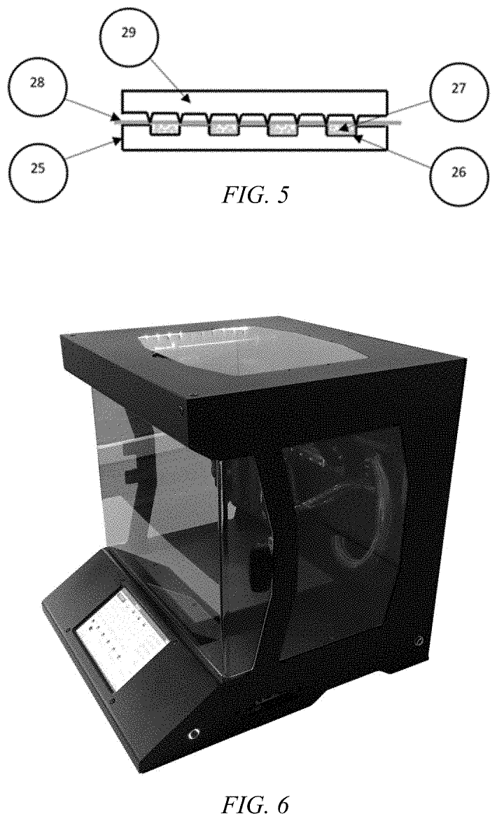

FIG. 5 is a cross-section of an alternate embodiment of the 3D printing surface 2 which features a precision contoured surface 25 with wells for receiving a liner material 26, a payload 27 and a capping material 28 which may then be die-cut after 3D printing with a die 29 or alternatively cut with a laser or waterjet. The liner material 26 and capping material 28 may be electrospun or electrosprayed with a biodegradable polymer and the payload 27 may be comprised of electrosprayed nanoparticles.

FIGS. 6-15 show yet additional aspect to provide even further context for this disclosure. While certain examples are provided in these figures, the disclosure is not limited to just these examples.

FIG. 6 shows a bioprinting platform housing multiple extrusion technologies, according to an embodiment of the disclosure.

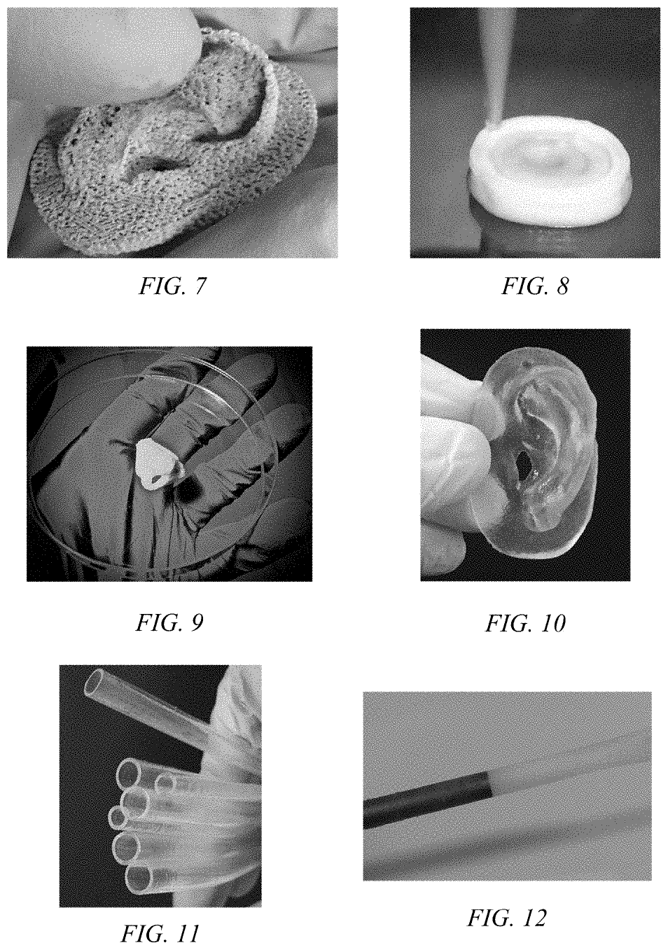

FIG. 7 shows an ear-shaped porous implantable scaffold printed using an FDM extruder, according to an embodiment of the disclosure.

FIG. 8 shows a triple concentric circular print which used 3 pneumatic extruders, according to an embodiment of the disclosure.

FIG. 9 shows a nose-shaped print with a hydrogel material, according to an embodiment of the disclosure.

FIG. 10 shows a flexible ear-shaped PDMS construct formed by casting PDMS into an FDM-printed ABS mold, according to an embodiment of the disclosure.

FIG. 11 shows flexible, thin tubular PDMS constructs, according to an embodiment of the disclosure.

FIG. 12 shows a nanofibrous blood vessel scaffold being pulled of a metal rod, according to an embodiment of the disclosure.

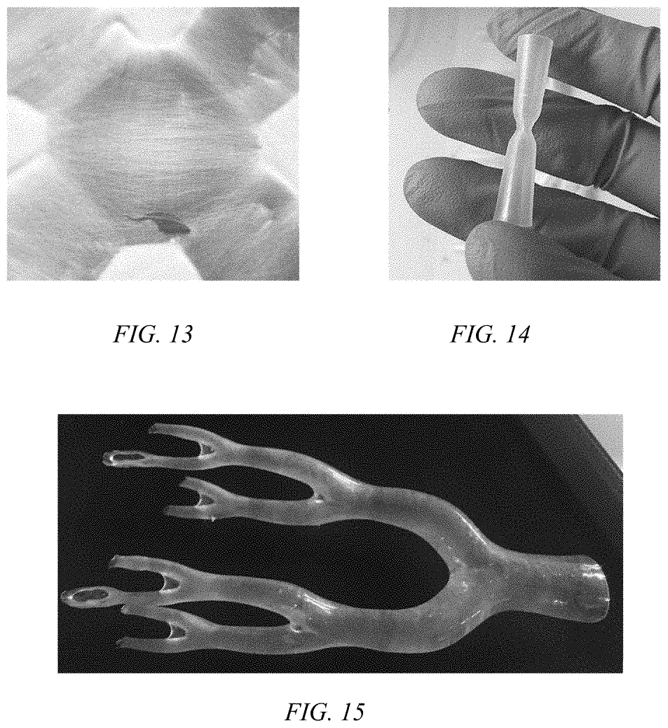

FIG. 13 shows nanofibers aligned perpendicularly to each other printed with an electrohydrodynamic printhead, according to an embodiment of the disclosure.

FIG. 14 shows a blood vessel model printed to simulate a blood clot, according to an embodiment of the disclosure.

FIG. 15 shows a blood vessel model printed to simulate a blood clot, according to an embodiment of the disclosure.

One skilled in the art would recognize that the printhead #4 may have multiple material inputs and the outputs from a multiplicity of inputs could optionally mix within or outside of the printhead prior to the material being deposited on the build surface.

While this disclosure has described certain embodiments and generally associated methods, alterations and permutations of these embodiments and methods will be apparent to those skilled in the art. Accordingly, the above description of example embodiments does not define or constrain this disclosure. As a non-limiting example, one skilled in the art will recognize that other material dispensing and building up means may be combined with a primary electro-hydrodynamic means including, but not limited to positive material displacement, inkjet displacement, piezoelectric displacement, laser curing, microvalve displacement, ultraviolet light curing, and fused deposition means. As another non-limiting example, certain embodiment of the present disclosure would detect a reduction in the field strength (such as excess of material building up on the build surface) and increase the voltage proportionately. Other changes, substitutions, and alterations are also possible without departing from the spirit and scope of this disclosure, as defined by the following claims.

What is claimed is:

1. A device for fabricating three-dimensional organic constructs, or biological objects, from one or more fluidic mediums capable of organic synthesis and/or solidification whose deposition is directed by a digital representation of the object, the device comprising:
a planar build plate for receiving successive layers of a build material therein,
an array of at least one printhead disposed above the planar build plate, wherein the at least one printhead is configured for selectively dispensing material utilizing a combination of electro-hydrodynamic and another bioprinting mechanism of depositing material onto a build surface or previous layer of build material, forming successive cross-sectional laminae of said object at a two-dimensional interface whereby a three-dimensional object is extracted from a substantially two-dimensional planar surface.

2. The device of claim 1, wherein
the planar build plate is replaced with a fluid filled tank that contains a viscous and/or electrorheological fluid that helps support the build material during the layering process and receiving successive layers of a build material therein and an array of at least one printhead disposed above the fluid filled tank, and
at least one printhead is configured for selectively dispensing material utilizing a combination of electro-hydrodynamic and/or pneumatic mechanisms of depositing a material onto the build material, forming successive cross-sectional laminae of said object at a two-dimensional interface whereby a three-dimensional object is extracted from a fluid filled tank.

3. The device of claim 1, wherein the three-dimensional object is fabricated from non-biological materials.

4. The device of claim 1, wherein
the printhead is directed above the build surface or build material and a second precision locating contact is disposed below the build surface, by which an electrostatically charged material is directed from the printhead to a precise location from its affinity with the opposing or differential charge of the precision locating contact that can be moved in the X and Y plane below the build surface, or
the precision locating remaining stationary while the build surface moves in a multiplicity of directions.

5. The device of claim 1, wherein the device is adjacent to and connected with another device such as another 3D printing device, a bioreactor, post-processing device or an incubator in order to maintain a sterile environment during the transfer of the built material from one system or device to another.

6. The device of claim 1, wherein a cleaning station, a calibration station, or both are connected to the printing surface wherein both the printing surface and station(s) can be translated in one or more dimensions to allow all the 3D printing extruders to reach said station(s), or translated in the opposite direction to allow all 3D printing extruders to reach the printing surface.

7. The device of claim 1, wherein the printhead has one or more fluid inlets that are controlled by a series of check valves, the actuation of which is controlled independently by an external controller.

8. The device of claim 1, wherein the device has closed-loop control of the strength of the electric field by automatically adjusting the voltage or the needle-to-collector distance based on the measurement of the electric field with one or more sensors.

9. The device of claim 1, wherein the system is provided ultrasonic-based offset calibration for the purpose of assisting the location of a precise position of one or more deposition device's extrusion orifice in one or more dimensions.

10. The device of claim 1, wherein one or more capacitive sensors are located in or around the build surface are used to detect the printhead position or the position of the extrusion orifice as it is moved, and to augment the detection of the printhead position, a voltage may be applied to the printhead to further assist its detection.

11. The device of claim 1, wherein the build surface is composed of, or in the proximity of a plurality of electrodes whose respective voltages may be controlled independently from one another.

12. The device of claim 1, wherein
the printing process is improved by creating nanofibrous and/or nanoporous containers with a payload wherein a printing surface is first created to have microwells and function as a carrier onto which nanofibers are deposited using electro-hydrodynamic and/or other means, and
the nanofibers are deposited on top of the previously deposited build material, and eventually, the 3D printed build material is separated from the machined carrier using a laser cutter or by other mechanical removal means.

13. The device of claim 1, wherein the printing process is improved by controlling the diameter of electrohydrodynamic-generated fibers in real-time, wherein one input channel of solution contains a low concentration of solute and a second input channel of solution contains a much higher concentration of solute, both of which have independently controlled flow rates and both of which mix prior to extrusion which effectively allows the precise control of solute concentration at the output orifice by adjusting the relative flow rates.

14. The device of claim 13, wherein a third channel is used to quickly withdrawal solution at times in which the fiber diameter needs to be changed.

15. The device of claim 13, wherein the difference between the input channels is the molecular weight of the solute.

16. The device of claim 13, wherein the input channels have different molecular weights and different concentrations.

17. The device of claim 13, wherein the input channels have different molecular weights, concentrations, or chemical composition.

18. The device of claim 13, wherein any number of input channels can be combined/mixed in any desirable ratio and output to any number of output channels.

19. The device of claim 1 for fabricating a three-dimensional organic construct, comprised by selectively dispensing build material using a combination of electrohydrodynamic and one or more bioprinting deposition systems, thereby selectively dispensing successive cross-sectional laminae of the construct and then extracting the construct from the build surface.

20. The device of claim 1, wherein electrohydrodynamic printing a construct consists of dispensing build material using electrohydrodynamic extrusion onto a build surface composed of or in proximity to a plurality of electrodes whose voltage levels are independently controlled to guide the deposition of the build material.
